(19) United States
(12) Patent Application Publication
(10) Pub. No.: US 2013/0013371 A1
(43) Pub. Date: Jan. 10, 2013

(54) SYSTEM AND METHOD FOR TRACKING RETAIL SALES PERFORMANCE

(76) Inventors: Norik Katsakhyan, Dunkirk, MD (US); Ryan Connell Durham, Dunkirk, MD (US); Nona Katsakhyan Durham, Dunkirk, MD (US)

(21) Appl. No.: 13/175,934

(22) Filed: Jul. 4, 2011

(51) Int. Cl. G06Q 10/00

(52) U.S. Cl. 705/7.29

(57) ABSTRACT

Disclosed herein are systems, methods, and non-transitory computer-readable storage media for tracking retail performance. A system configured to practice the method monitors transactions at a merchant point of sale and determines, from the transactions, a sales rate for a product. If the sales rate for the product goes below a target sales rate associated with the product, the system identifies a responsibility hierarchy associated with the product, wherein the responsibility hierarchy indicates a chain of responsible parties for the product, and sends an alert for the product to at least one of the responsible parties. The alert can be an audible alert, a visual alert, a vibration, a printed alert, a list entry, and/or a database entry. The system can send the alert to a responsible party and/or a supervisor of the responsible party. The alert can be associated with a period of time to resolve the alert.

### BACKGROUND

1. Technical Field

The present disclosure relates to sales performance and more specifically to tracking specific sales rates and generating alerts.

2. Introduction

In retail store management, certain employees are links in a chain to get items on the shelf for consumers to discover and purchase. When items in a store are not available, the store management may not immediately know that the items are unavailable, who is responsible, or how to fix the problem. This difficulty can lead to lost sales and/or unsatisfied customers. This and other retail management problems can cause inefficiencies in the retail industry.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches disclosed herein provide a way to easily track issues with items in a retail or other sales environment, and provide a way to resolve those issues. Item sales issues are discovered when a sales rate of an item changes from an expected sales rate. For example, when a sales rate of milk dips below an expected sales rate, then it can be inferred that the inventory or availability of milk on the store shelves has an issue. Based on a database indicating who is responsible for the milk, notifications can be sent out to one or more various responsible parties to resolve the issue within a given time frame. Notifications can expire, escalate or transfer to other responsible parties, and so forth.

Disclosed are systems, methods, and non-transitory computer-readable storage media for tracking sales performance at a point of sale. A system configured to practice the method first monitors transactions at a merchant point of sale. The system determines, from the transactions, a sales rate for a product. A sales rate is a number of items sold over a given time period. A time period associated with the sales rate can be based on a type of the product, and different products can be associated with different time periods. The target sales rate can be set manually or automatically. The target sales rate can be based on a sales goal. The target sales rate can be set based on historical sales data.

If the sales rate for the product goes below a target sales rate associated with the product, the system identifies a responsibility hierarchy associated with the product, wherein the responsibility hierarchy indicates a chain of responsible parties for the product, and sends an alert for the product to at least one of the responsible parties. The alert can be an audible alert, a visual alert, a vibration, a printed alert, a list entry, and/or a database entry. The system can send the alert to a responsible party and/or a supervisor of the responsible party.

The alert can be associated with a period of time to resolve the alert. If the at least one of the responsible parties does not resolve the alert within the period of time, the system can send an escalation alert to a supervisor of the at least one of the responsible parties. In one aspect, the alert is a change of a status from one state to another state. The system can represent the status using a linear scale of color codes. For example, green can represent an acceptable state, yellow can represent a warning state, and red can represent a critical state.

In one variation, the system further determines an expiration period for the product, and generates, based on at the sales rate and the expiration period, a recommended quantity of the product to order. The recommended quantity can be further based on current inventory of the product. The system can automatically order the recommended quantity of the product.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example system configuration for tracking sales rates and sending alerts based on the sales rates;

FIG. 3 illustrates an example method embodiment

FIG. 4 illustrates a second example system configuration including a responsibility chain/hierarchy; and

FIG. 5 illustrates an exemplary responsibility chain/hierarchy of FIG. 4 in more detail.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

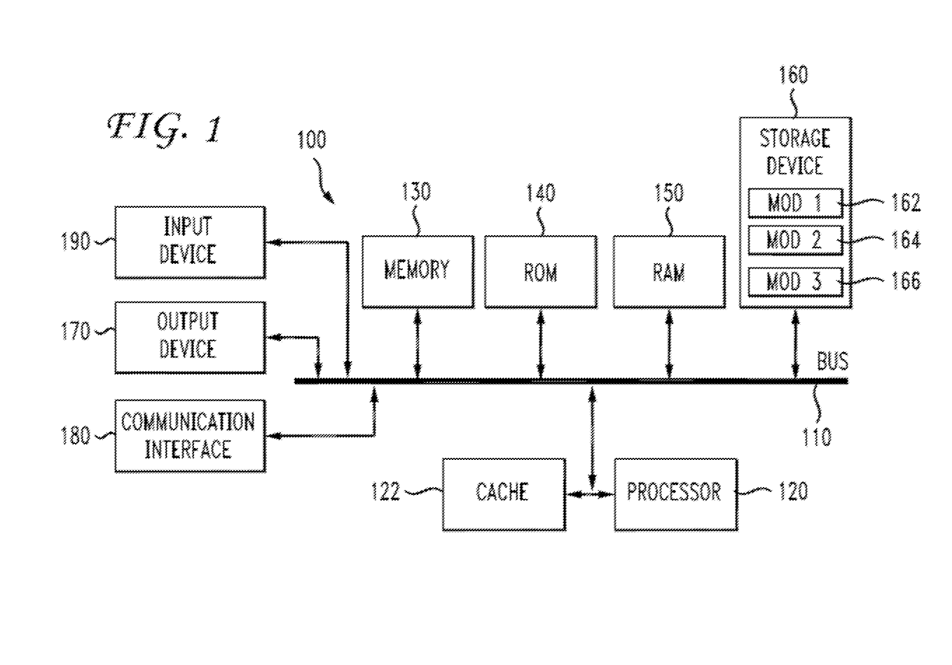

The present disclosure addresses the need in the art for improving retail efficiency. A brief introductory description of a basic general purpose system or computing device in FIG. 1 which can be employed to practice the concepts is disclosed herein. A more detailed description of tracking retail sales rates, sending notifications, and variations thereof shall be discussed as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multi-modal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

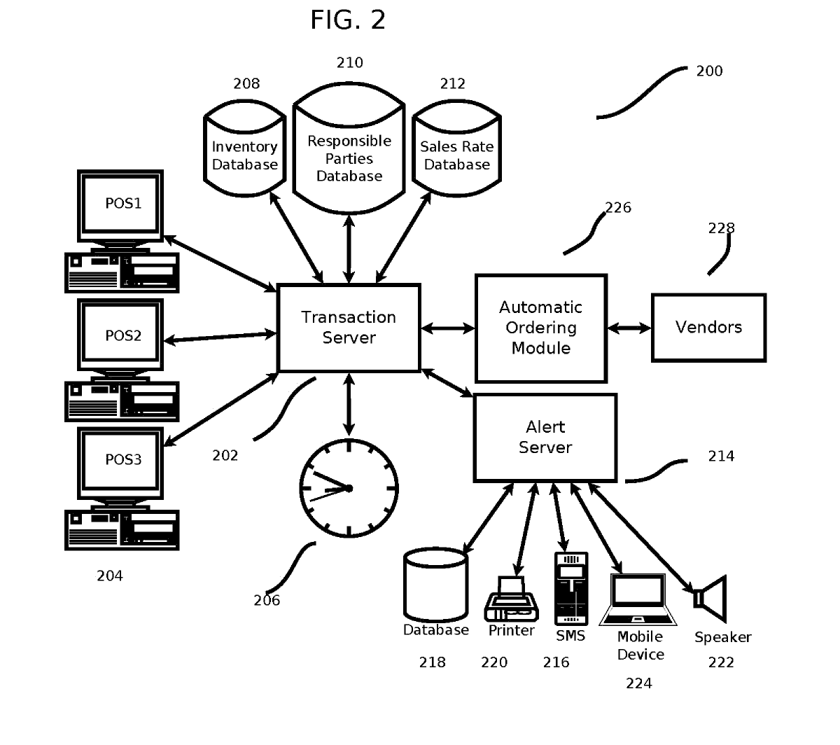

Having disclosed some components of a computing system, the disclosure now turns to FIG. 2, which illustrates an example system configuration 200 for tracking sales rates and sending alerts based on the sales rates. A transaction server 202 receives sales data from one or more points of sale 204, such as POS1, POS2, and POS3. The sales data can describe what is sold as well as associated information. The points of sale 204 can report the sales data in real time as transactions occur or can report the sales data in batches on a periodic basis. The transaction server 202 and/or the points of sale 204 can determine a timestamp for the sales data from a local or centralized clock 206. The transaction server 202 generates sales rates for items sold at the points of sale 204 over a period of time, and compares the sales rates to a sales rate database 212. If, for the period of time, the sales rate for a particular item is less than a threshold sales rate, the transaction server 202 looks up those who are responsible for that particular item in a responsibility parties database 210, which can be a hierarchy, a chain, and so forth. The responsible parties for a particular item may be different from other items, and the responsible parties can be specific individuals and/or organizational roles. The specific set of responsible parties can change for a given item at different times. The transactions server 202 communicates with an alert server 214 to transmit a notification intended for those who are responsible for that particular item. The notification can be transmitted to individuals within a single organization, such as a single retail store, or can be transmitted to individuals across multiple organizations, such as a retailer and a vendor or distributor.

The alert server 214 can send alerts via SMS 216, entries or modifications to a database 218, physical printout 220, audible output 222, direct communication 224 with a mobile device such as a smart phone, pager, tablet, or other electronic device. In another variation, the alert server 214 changes a light or other display from one color to another color.

The alert can optionally include a particular time in which an employee or other user is supposed to discover what is causing the below expected sales rate for the item. The employee can then flag the issue as resolved, thereby ending the alert, or can pass responsibility for the issue to someone else if the issue is not resolvable within that employee's abilities or permissions.

The transaction server 202 can track sales rates in the sales rate database 212 and update the sales rate database 212 accordingly. The transaction server 202 can also query and/or update an inventory database 208. When inventory dips below a desired level, the transaction server 202 can initiate ordering additional inventory automatically. For example, the transaction server 202 communicates with an automatic ordering module 226. The automatic ordering module 226 can consider the sales rate for the product, an inventory level for the product, expiration information for the product (if the product is perishable, for example), and other relevant factors, when making the decision for when and how much of the product to order from vendors 228. In one aspect, the automatic ordering module 226 suggests orders for approval by a user.

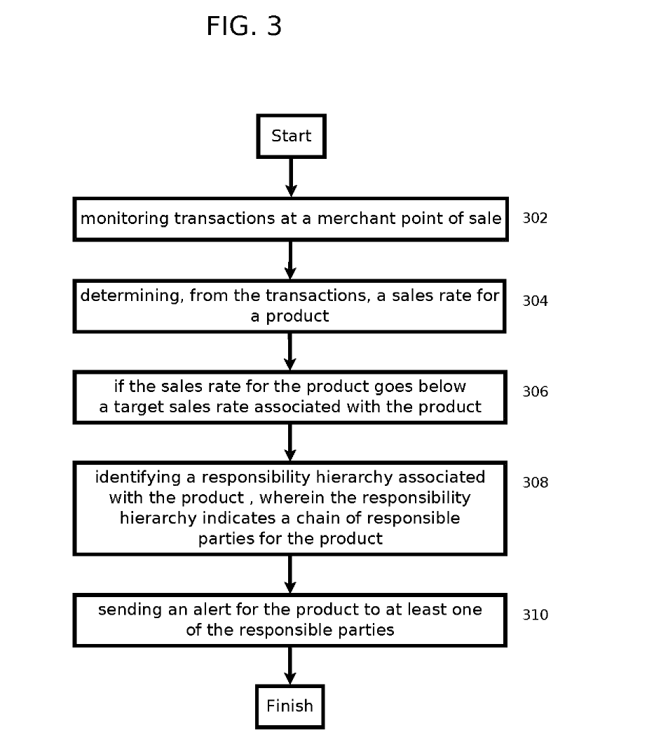

Having disclosed some basic system components and concepts, the disclosure now turns to the exemplary method embodiment shown in FIG. 3. For the sake of clarity, the method is discussed in terms of an exemplary system 100 as shown in FIG. 1 configured to practice the method and track sales performance data. The steps outlined herein are exemplary and can be implemented in any combination thereof, including combinations that exclude, add, or modify certain steps. The system 100 monitors transactions at a merchant point of sale (302). The system determines, from the transactions, a sales rate for a product (304). A sales rate is a number of items sold over a given time period. A time period associated with the sales rate can be based on a type of the product, and different products can be associated with different time periods. The target sales rate can be set manually or automatically. The target sales rate can be based on a sales goal. The target sales rate can be set based on historical sales data.

If the sales rate for the product goes below a target sales rate associated with the product, the system identifies a responsibility hierarchy associated with the product, wherein the responsibility hierarchy indicates a chain of responsible parties for the product (306), and sends an alert for the product to at least one of the responsible parties (308). The alert can be an audible alert, a visual alert, a vibration, a printed alert, a list entry, and/or a database entry. The system can send the alert to a responsible party and/or a supervisor of the responsible party.

The alert can be associated with a period of time to resolve the alert. If the at least one of the responsible parties does not resolve the alert within the period of time, the system can send an escalation alert to a supervisor of the at least one of the responsible parties. In one aspect, the alert is a change of a status from one state to another state. The system can represent the status using a linear scale of color codes. For example, green can represent an acceptable state, yellow can represent a warning state, and red can represent a critical state.

The system can optionally determine an expiration period for the product, and generate, based on at the sales rate and the expiration period, a recommended quantity of the product to order. The recommended quantity can be further based on current inventory of the product. The system can automatically order the recommended quantity of the product.

The disclosure now turns to a discussion of various schedules for tracking sales rates, such as a 1-hour sales rate schedule, a 2-hour sales rate schedule, a 3-hour sales rate schedule, a 6-hour sales rate schedule, and a 12-hour sales rate schedule. Each of these schedules is discussed with exemplary specific items and sales to illustrate how the system can process the sales rates.

The disclosure turns first to the exemplary 1-hour sales rate schedule, discussed in terms of Table 1, below. The numbers 1-20 represent different retail items that have different sales rates, such as televisions, produce, milk, aspirin, socks, bar stools, paper towels, paint thinner, toothpaste, rakes, and so forth. Different items sell at different rates, making different time spans more conducive to particular products. For example, milk may sell frequently enough to be measured on an hourly basis, while paint thinner may sell so infrequently to be measured on a 12-hour basis or on some longer basis. These time spans for sampling the rate are exemplary and can include these or other time spans. Time spans can overlap. One item can be assigned to different time spans at different times of day, days of the month, and so forth.

TABLE 1

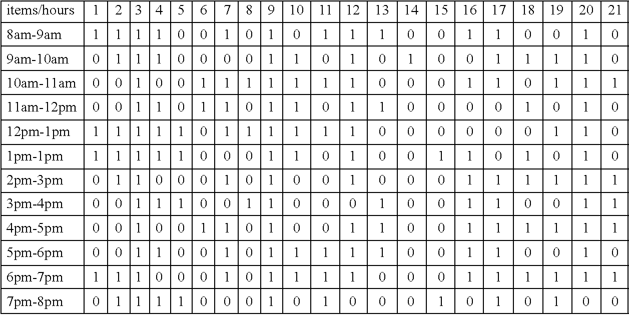

The system tracks sample items 1-21 to see if at least one of each of those items is sold in each one hour period of time. In this example, items 3 and 9 get put on a 1 hour control system because at least one of each of those items is sold in each one hour period of time.

TABLE 2

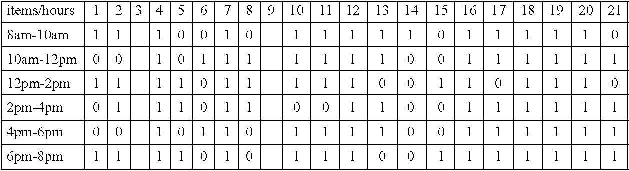

Table 2 illustrates a 2-hour sales rate schedule. The system can track the remaining sample items to see if at least one of each of those items is sold in each two hour period of time. As seen, items 3 and 9 are absent from the table because they are already put on a 1 hour control system as shown in Table 1. In this example, items 4, 7, 12, 16, 18, 19 and 20 get put on a 2 hour control system because at least one of each of those items is sold in each two hour period of time.

TABLE 3

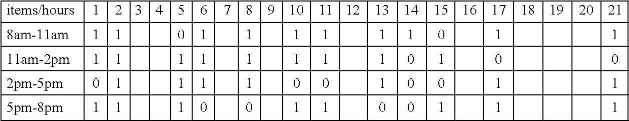

Table 3 illustrates a 3-hour sales rate schedule. The system tracks the remaining sample items to see if at least one of each of those items is sold in each three hour period of time. In this example, only item 2 gets put on a 3 hour control system because at least one of that item is sold in each three hour period of time. Items 3, 4, 7, 9, 12, 16, and 18-20 are absent from this table because they were previously put on a different schedule.

TABLE 4

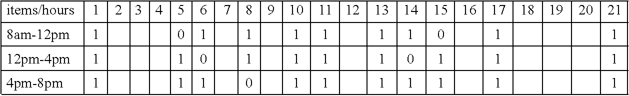

Table 4 illustrates a 4-hour sales rate schedule. The system tracks the remaining sample items to see if at least one of each of those items is sold in each four hour period of time. In this example, items 1, 10, 11, 13, 17 and 21 are put on a 4 hour control system because at least one of each of those items is sold in each four hour period of time. Items 2-4, 7, 9, 12, 16, and 18-20 are absent from this table because they were previously put on a different schedule.

TABLE 5

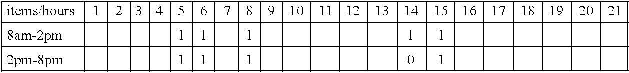

Table 5 illustrates a 6-hour sales rate schedule. The system tracks the remaining sample items to see if at least one of each of those items is sold in each six hour period of time. In this example, items 5, 6, 8 and 15 get put on a 6 hour control system because at least one of each of those items is sold in each six hour period of time. Items 1-4, 7, 9-13, and 16-20 are absent from this table because they were previously put on a different schedule.

TABLE 6

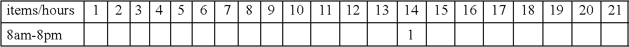

Table 6 illustrates a 12-hour sales rate schedule. The system tracks the remaining sample items to see if at least one of each of those items is sold in each twelve hour period of time. In this example, only item 14 gets put on a 12 hour control system because at least one of that item is sold in each twelve hour period of time. Items 1-13, and 15-20 are absent from this table because they were previously put on a different schedule.

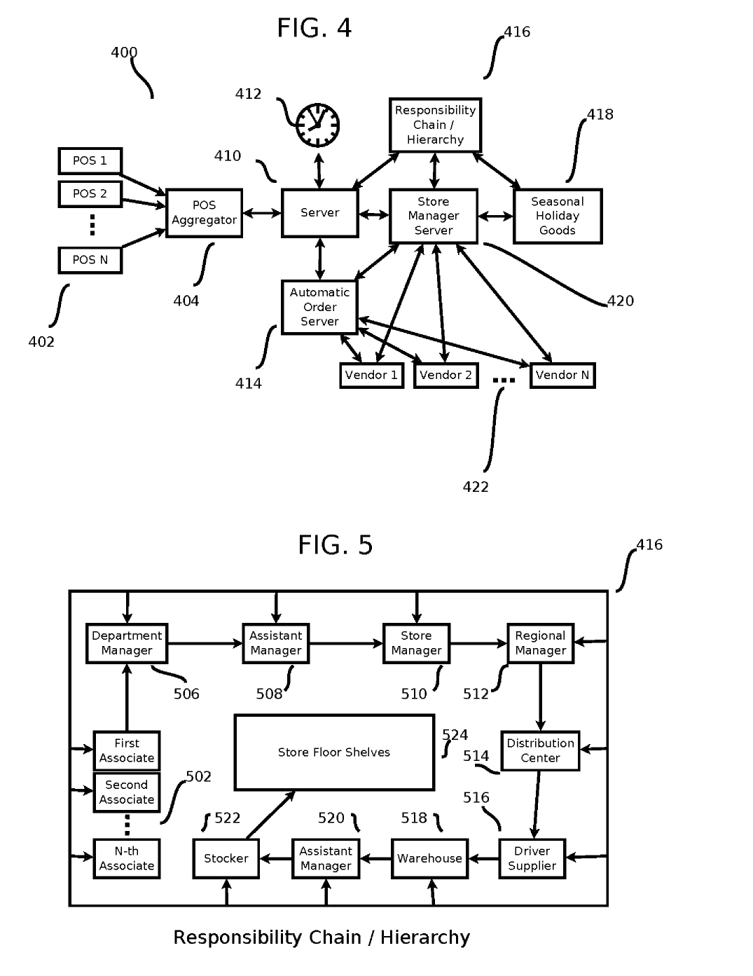

FIG. 4 illustrates a second example system 400 including a responsibility chain/hierarchy. The example system 400 can cover a single store, multiple stores within an organization, and/or stores across multiple organizations. In this system 400, various points of sale (POS) 402 process transactions of item. A POS aggregator 404 receives POS information from the POSs 402. The POS aggregator 404 sends at least part of the POS information to a server 410, which calculates, based on an optional time source 412, a sales rate for items in inventory. For example, the server 410 can calculate that the sales rate for 16 oz Dawn Dish Soap is 14.3 per hour. If the target sales rate for the 16 oz Dawn Dish Soap is 14 per hour, then the sales rate is acceptable. However, if the actual sales rate is 0.3, then the lower than normal sales rate indicates a problem, such as unavailability of the item on the shelf, the item is hidden or in a wrong location, the item is marked with an improper price, and so forth. The server 410 can send a signal to a responsible party in the responsibility chain/hierarchy 416 to determine what the problem is and resolve it.

The server 410 communicates with an automatic order server 414, which can automatically order items from vendors 422, if the sales rate and/or inventory information indicates that additional items are needed. The automatic order server 414 can limit orders based on a shelf life of the item. For example, canned foods may have a shelf life of a year or more, while milk may have a shelf life of two weeks.

The server 410 can communicate with the store manager server 420. The store manager server 420 optionally allows the manager to manually determine which items are allowed to enter this system. Through the store manager server 420, a store manager can set the desired sales rate for items, specific sales rate periods, view history, and so forth. The store manager server 420 can disable the tracking system, for example, if a heavy snow fall shuts down the store or significantly restricts the number of customers visiting the store. The store manager server 420 can also generate daily, weekly, monthly, or other reports. The seasonal holiday goods server 418 can track items that are infrequently available. The system can track which items sell well and send an alert to order particular seasonal items according to sales rate history, such as wreaths, Easter baskets, or fireworks.

The information, structure, and relationships within the responsibility chain/hierarchy 416 can be kept secret from outsiders as a trade secret. The server 410 can make certain sales rate information available for vendors 422 or for others, via a privately or publicly available application programming interface (API). Users viewing the sales rate via the API can provide comments and/or feedback for the product associated with the sales rate.

FIG. 5 illustrates an exemplary responsibility chain/hierarchy 416, as shown in FIG. 4 above, in more detail. Other variations can be used in place. These examples are discussed in terms of exemplary status colors. A green status means everything is acceptable and the sales rates are within or exceed expected sales rates. A yellow status is an alert or a warning that the sales rate has fallen below a desired threshold. A red status is a critical alert that occurs after being in a yellow state for too long. A blue status indicates that the responsibility for the item has been escalated, transferred, or passed along to another responsible person, thereby changing the status for that responsible person to yellow or red. A brown status indicates that an order was placed by someone else somewhere earlier in the responsibility chain. A different color, such as pink, can indicate items that are associated with a desired sales rate, but are not approved by the manager. The manager can change the status of any item at any time by taking an item out of the system and putting it on a waiting list indicated by pink color. These statuses can be based on the sales rate dropping too far or below a desired threshold for an extended period of time.

TABLE 7

| | | | | | | | | | |
|---|---|---|---|---|---|---|---|---|---|
| rate classification | A | B | C | D | E | F | G | H | O |
| rate hours | 0.5 | 1 | 2 | 3 | 4 | 6 | 12 | day or | not |
| | | | | | | | | days | rated |

The items in the system that are in pink in the waiting list are classified by categories. Table 7, above, shows several item classes. Class A is items that sell at a half an hour rate. Class B is items that sell at a one hour rate, and so forth. Class H items sell on a daily or even several days rate. Class O items are not rated. When the manager pulls up the items from the waiting list in order to put them into the system, the class rating gives detailed information on items sales rate category.

The example responsible parties chain includes associates 502, the department manager 506, an assistant manager 508, a store manager 510, a regional manager 512, a distribution center 514, a driver or supplier 516, a warehouse 518, an assistant manager 520, and a stocker 522 who stocks the store shelves 524. If everything is acceptable, then every responsible party's status is green.

If the first and second associate 502 needs to get more items, he sends an order for more items to the next person in the chain, the department manager 506. Then, the associate 502 status turns blue and the department manager 506 status is yellow. The status of everyone else after the department manager 506 turns brown, indicating that an order was made.

Then, the department manager 506 passes the order to the next person in the chain, assistant manager 508. Then the department manager 506 status turns blue, and the assistant manager 508 status turns yellow. The statuses of people further down the chain remain unchanged.

The assistant manager 508 passes the order to the next person in the chain, the store manager 510. Then the assistant manager 508 status turns blue, and the store manager 510 status turns yellow. The statuses of people further down the chain remain unchanged. This process continues until the assistant manager 520 passes the order to the stocker 522. The stocker 522 then stocks the store floor shelves 524, resetting the entire system to a green status. In three cases the system will kick the item out of the system into the pool where it will receive a new rate like a new item. The first case is when the price of the item changes. The second case is when the packaging of the item changes. The third case is when the primary location of the item changes within the store.

The disclosure now turns to other specific examples.

TABLE 8

| | | | | | | | | |
|---|---|---|---|---|---|---|---|---|
| hours | 6/am-7 | 7-8 | 8-9 | 9-10 | 10-11 | 11-12 | 12-1 | 1-2 |
| items sold | 1 | 2 | 4 | 6 | 1 | 4 | 0 | 6 |
| hours | 2/pm-3 | 3-4 | 4-5 | 5-6 | 6-7 | 7-8 | 8-9 | 9-10 |
| items sold | 11 | 0 | 4 | 1 | 2 | 0 | 3 | 1 |

This example refers to Table 8 above. From 6 a.m. To 7 a.m., the POS shows a single sale. In the following period, 7 a.m. to 8 a.m., the POS shows two sales, and so forth. Although from 12 p.m. to 1 p.m. the POS reports no items sold, the system does not trigger the alert because in the hour following that period, i.e. from 1 p.m. to 2 p.m. the POS reports 6 items sold. The system can mark those sections green for the entire chain of responsible parties for each of these time periods because the sales rate is within acceptable bounds.

TABLE 9

| | | | | | | | | | |
|---|---|---|---|---|---|---|---|---|---|
| hours | 6/ | 7-8 | 8-9 | 9-10 | 9.3 | 10-11 | 11-12 | 12-1 | 1-2 |
| | am-7 | | | | | | | | |
| items sold | 1 | 2 | 0 | 0 | 1 | 0 | 0 | 0 | 0 |

| | | | | | | | | |
|---|---|---|---|---|---|---|---|---|
| hours | 2/ | 3-4 | 4-5 | 5-6 | 6-7 | 7-8 | 8-9 | 9- |
| | pm-3 | | | | | | | 10 |
| items sold | 0 | 0 | 1 | 0 | 0 | 0 | 1 | 0 |

Table 9 illustrates different sales data from that shown in Table 8, and illustrates how the system handles that different sales data. From 6 a.m. to 7 a.m., the POS reports a single sale. From 7 a.m. to 8 a.m., the POS reports 2 sales. From 8 a.m. to 9 a.m., the POS reports no sales, but the system does not trigger the alert yet. At the beginning of the following hour period, 9 a.m. to 10 a.m., the POS reports no sales. Then the system triggers the alert, such as by changing the color to yellow. However at 9:30 a.m., the POS reports a sale, which triggers the next hour period to change from yellow back to green. From 10 a.m. to 11 a.m., the color can remain green. At 10:50 a.m. the first responsible person orders more items, which makes his screen blue and passes on the yellow color to the next person above in the chain, where the yellow stays from 10:50 a.m. to 12 p.m. In this case, if the system indicated that this product was somewhere in the back of the store, the system can optionally deny the person to send the request to the next person in the chain, his screen would not turn blue unless the store truly does not have that item in stock. As such his yellow warning is at risk of turning red. Once the first person's screen is blue and the item order is passed on to the next person in the chain, the system will not restore back to green even if that item is sold again.

TABLE 10

| | | | | | | | | | |
|---|---|---|---|---|---|---|---|---|---|
| hours | 6/am-7 | 7-8 | 8-9 | 9-10 | 9.3 | 10-11 | 11-12 | 12-1 | 1-2 |
| item | 1 | 2 | 0 | 0 | 1 | 0 | 0 | 0 | 0 |
| sold | | | | | | | | | |

| | | | | | | | | |
|---|---|---|---|---|---|---|---|---|
| hours | 2/pm-3 | 3-4 | 4-5 | 5-6 | 6-7 | 7-8 | 8-9 | 9-10 |
| item | | | | | | | | |
| old | 11 | 2 | 4 | 1 | 2 | 1 | 3 | 1 |

Table 10 illustrates different sales data from that shown in Table 8 or Table 9. In this scenario, from 6 a.m. to 7 a.m., the POS reports a single sale. From 7 a.m. to 8 a.m., the POS reports 2 sales. From 8 a.m. to 9 a.m., the POS reports no sales, but the system does not trigger the alert yet. At the beginning of the following hour period, 9 a.m. to 10 a.m., the POS reports no sales. Then the system triggers the alert, such as by changing the color to yellow. However at 9:30 a.m., the POS reports a sale, which triggers the next hour period to change from yellow back to green. From 10 a.m. to 11 a.m., the color can remain green. The first person in the chain discovers the product somewhere in back of the store and puts it on the floor and gets a 2 hour penalty/alert in red for 12 p.m. to 2 p.m. for not putting the items out on time. After 2 p.m., the alerts are cleared, and the system returns to a green status. Yellow periods at 9 a.m. to 10 a.m. and 11 a.m. to 12 p.m. are not penalties, and can just be warnings.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
monitoring transactions at a merchant point of sale;
determining, from the transactions, a sales rate for a product; and
if the sales rate for the product goes below a target sales rate associated with the product:
identifying a responsibility hierarchy associated with the product, wherein the responsibility hierarchy indicates a chain of responsible parties for the product; and
sending an alert for the product to at least one of the responsible parties.

2. The method of claim 1, wherein the alert is at least one of an audible alert, a visual alert, a vibration, a printed alert, a list entry, and a database entry.

3. The method of claim 1, wherein the alert is sent to a responsible party and a supervisor of the responsible party.

4. The method of claim 1, wherein the alert is associated with a period of time to resolve the alert.

5. The method of claim 4, further comprising:
if the at least one of the responsible parties does not resolve the alert within the period of time, sending an escalation alert to a supervisor of the at least one of the responsible parties.

6. The method of claim 1, wherein the alert is a change of a status from one state to another state.

7. The method of claim 6, wherein the status is represented by a linear scale of color codes, with green representing an acceptable state, yellow representing a warning state, and red representing a critical state.

8. The method of claim 1, wherein the target sales rate is set manually.

9. The method of claim 8, wherein the target sales rate is set based on a sales goal.

10. The method of claim 1, wherein the target sales rate is set automatically.

11. The method of claim 10, wherein the target sales rate is set based on historical sales data.

12. The method of claim 1, wherein a time period associated with the sales rate is based on a type of the product.

13. The method of claim 12, wherein different products are associated with different time periods.

14. The method of claim 1, further comprising:
determining an expiration period for the product; and
generating, based on the sales rate and the expiration period, a recommended quantity of the product to order.

15. The method of claim 14, wherein generating the recommended quantity is further based on current inventory of the product.

16. The method of claim 14, further comprising automatically ordering the recommended quantity of the product.

17. A system comprising:
a processor;
a memory storing instructions for controlling the processor to perform steps comprising:
monitoring transactions at a merchant point of sale;
determining, from the transactions, a sales rate for a product; and
if the sales rate for the product goes below a target sales rate associated with the product:
identifying a responsibility hierarchy associated with the product, wherein the responsibility hierarchy indicates a chain of responsible parties for the product; and
sending an alert for the product to at least one of the responsible parties.

18. The system of claim 17, wherein the alert is at least one of an audible alert, a visual alert, a vibration, a printed alert, a list entry, and a database entry.

19. A non-transitory computer-readable storage medium storing instructions which, when executed by a computing device, cause the computing device to perform steps comprising:
monitoring transactions at a merchant point of sale;
determining, from the transactions, a sales rate for a product; and
if the sales rate for the product goes below a target sales rate associated with the product:
identifying a responsibility hierarchy associated with the product, wherein the responsibility hierarchy indicates a chain of responsible parties for the product; and
sending an alert for the product to at least one of the responsible parties.

20. The non-transitory computer-readable storage medium of claim 19, wherein the alert is associated with a period of time to resolve the alert.
